(19) United States
(12) Patent Application Publication
(10) Pub. No.: US 2025/0333136 A1
(43) Pub. Date: Oct. 30, 2025

(54) Manufacturing method, an article, a device, and application method for providing high brightness, durable, foldable, sealed and fluorescent retroreflector

(71) Applicants: Paul Louis Acito, St Paul, MN (US); Tani Kathleen Maruyama, St Paul, MN (US); Anne Maruyama Walli, St Paul, MN (US); David Lee Wortman, Stillwater, MN (US)

(72) Inventors: Paul Louis Acito, St Paul, MN (US); Tani Kathleen Maruyama, St Paul, MN (US); Anne Maruyama Walli, St Paul, MN (US); David Lee Wortman, Stillwater, MN (US)

(21) Appl. No.: 18/679,903

(22) Filed: May 31, 2024

Related U.S. Application Data
(60) Provisional application No. 63/505,737, filed on Jun. 2, 2023.

(51) Int. Cl. B62M 3/12

(52) U.S. Cl. CPC B62M 3/12

(57) ABSTRACT

We present a manufacturing method, an article, a device, and application method for providing high brightness, durable, foldable, sealed, and fluorescent retroreflector to improve bicycle visibility at day, dusk and dawn and nighttime.

The fluorescent function provides the day visibility. The retroreflective function provides the nighttime visibility when illuminated by auto headlights. Both functions combine to provide visibility at dusk and dawn.

Typically, these materials are stiff and difficult to fold. The manufacturing method changes the material properties to allow folding around small radii, improving the ease of assembly, and providing an aesthetic and aerodynamic visibility solution.

### BRIEF DESCRIPTION OF THE FIGURES

FIG. 1 Standard Bicycle with Required Reflectors, which includes the 100 Bicycle, and may include the 101 Rear Stay, the 102 Chain Stay, the 103 Seat Tube, the 104 Top Tube, the 105 Front Tube, the 106 Down Tube, the 107 Stem, the 108 Handle Bar, the 109 Seat Post, the 110 Seat, the 111 Crank, the 112 Pedal, the 113 Back Wheel, the 114, Front Wheel, the 115 Spokes, the 116 Hub, the 117 Rim, the 118 Wheel Reflector, the 119 Front Fork, the 121 Back Reflector and the 122 Front Reflector.

FIG. 2. High Durable, Fluorescent, Retro Reflective Laminate Example, which includes the 200 Laminate Construction, the 201 Optional Over-laminate, the 202 Functional Article, the 203 Retro-Reflective Fluorescent Layer, the 204 Co-extruded Plastic Layer, the 205 PSA Layer, the 206 Liner and the 207 Heat/Pressure embossed fold lines.

FIG. 3. Bicycle with Universal Reflector, which includes the 100 Bicycle, and includes at least one micro-prismatic, retroreflective, fluorescent, sealed and folded reflector such as 300 Dogbone with 305 Center Hole, or the 302 Dogbone Spoke Span, the 303 Dogbone Spoke Wrap or the 304 Dogbone Rear or Front Reflector, or other design shapes.

FIG. 4. Winglet Manufacturing Article, which includes the 400 Winglet Manufacturing Article, which may include the 401 Center Hole, the 402 Side Flaers, the 403 Tab, the 404 Heat/Pressure embossed fold lines and the 405 Winglet.

FIG. 5. Bicycle With front and back Winglet which includes the 401 Bicycle with 405 Winglets placed on either the 115 Spoke on the 113 Back Wheel or the 114 Front Wheel or both.

FIG. 6. Origami Ringlet with Additional heat and Pressure Created Fold Points, which includes the 500 Ringlet and multiple 501 Heat/Pressure created Fold Points as shown in the 502-Fold Process and Packaging.

FIG. 7. Bicycle with Ringlet or Moonlet, which includes the 501 Bicycle with Ringlet, and may include one 500 Ringlet, a 503 Assembly, 504 Segment and 505 Splice or the 506 Assembly, with at least one 507 Moon Phase segment.

FIG. 8. 507 Assembly 1″ Segment Ringlet with Kiss Cut and Liner, which includes the 507 Ringlet, which includes the 500 Ringlet, with the 508 Tab, the 509 Score and the 510 Adhesive where the 201 Optional Overlaminate and 202 Functional Article are kiss cut through to the 206 Liner.

FIG. 9. Rim Winglet, which may include the 400 Winglet with additional 601 Heat and Pressure Fold Lines, the 602 Folded Reflector applied to the 117 Rim, creating the 603 Wheel with Folded Reflector.

FIG. 10. Bicycle Rim Winglet, which includes the 601 Bicycle, which includes the 100 Bicycle and at least one 602 Rim Winglet.

FIG. 11. Bicycle with Rim Wrap, which include a 400 Winglet with two additional 701 heat and pressure fold lines, creating the 702 Folded Reflector applied to the 117 Rim.

FIG. 12. Bicycle with at least one 200 Laminate Construction, which includes the 202 Functional Article, the 203 Retro-Reflective Fluorescent Layer, the 204 Co-extruded Plastic, the 205 PSA and the 207 Heat/Pressure embossed fold lines and may include the 201 Optional Overlaminate and the 206 Liner

### PURPOSE OF INVENTION

Current bicycle reflectors, designed after the Consumer Products Safety Commission (CPSC)/National Highway Traffic Safety Administration (NHTSA) standard have several deficiencies, enumerated here. In addition, all 50 states plus the District of Columbia have regulations which reference the CPSC and NHTSA standards. Finally, most countries have national and local regulations on bicycle reflectors.

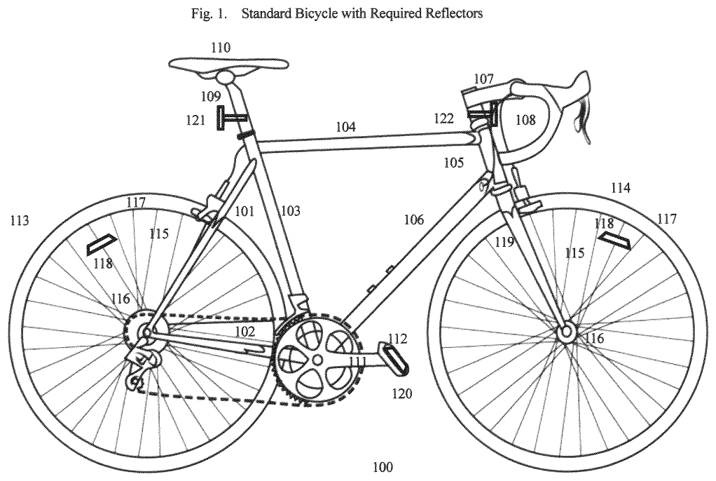

Referring to FIG. 1, the current back reflector, 118, the front reflector, 119, the pedal reflectors, 120, and the wheel spoke reflectors, 121 required on every bicycle and ebike sold in the USA are breakable, have poor angularity, are unbalanced, and only provide improved visibility and safety during times when drivers see them with the use of their headlights, principally during darkness. It is estimated that one-third to one-half of bicycles have lost their wheel reflectors or have deliberately removed them.

Alternatively, the consumer may take the reflectors off, or be considered as a decoration for children, thereby making the bicycle less safe, and not meeting the CPSC standards.

Additionally, current bicycle reflectors are not optimized to take advantage of newer automotive headlights, such as HID, LED, that provide different color gamut and spectrum wavelengths compared to older incandescent and filament headlights. Further, many cars are now equipped with ultrasonic, camera or visual, ultrasonic and LIDAR image detection and ranging systems. Current bicycle reflectors are neither designed nor optimized to function with these detection systems. There are advances in the science of visual and image recognition and in the development of artificial intelligence systems that provide a better understanding of how human's see objects, and how detection systems can be optimized to detect objects.

As a result of the deficiencies in the existing CPSC/NHSTA required bicycle reflectors, bicycling consumers have begun to rely upon several approaches to provide nighttime visibility. Some may use beaded reflectors applied to a cloth or plastic substrate. An adhesive layer may be used to attach the reflector to various locations on the bicycle, including the wheel rim, the frame, or the pedals. These tend to provide brightness consistent with low brightness beaded materials and lower than the advanced micro-prismatic cube corner designs.

Other reflectors may use a rigid prismatic plate or element attached to the spokes, bike pedal, handlebar, seat post or other part of the bicycle to face forward, backwards, or sideways as required by CPSC/NHTSA. These reflectors are rigid, not very bright, have poor angularity, exhibit poor durability and only function when illuminated by auto headlights and provide little to no additional visibility during daylight.

Other reflectors use a micro-replicated prismatic plastic or vinyl film with metal coatings applied to the prismatic structure to maintain reflectivity. These may be thinner and lighter than rigid prismatic plates, have higher, but not optimized brightness, but work only when illuminated by car headlights and have low durability and yellow with environmental aging.

Other micro-replicated prismatic plastic films may have an air gap behind the prisms, increasing brightness, angularity, and reflectance, but may not provide the conformity required during manufacturing, assembly, and installation processes.

None of the above provides daylight, dawn or dusk visibility and function only when illuminated by auto headlights at night.

The vast majority of bicycle miles (an estimated 95%) are logged during daylight, dawn, and dusk lighting conditions. This percentage is even higher for cyclists under the age of 18.

### How Invention Solves the Problems Above

The Long Term Durable Foldable Fluorescent Reflector uses a state of the art micro-prismatic, retro-reflective, and fluorescent material that has much higher day/night/dawn/dusk performance than existing reflectors. These reflectors may be up to 2 times brighter than the other standard reflectors previously used.

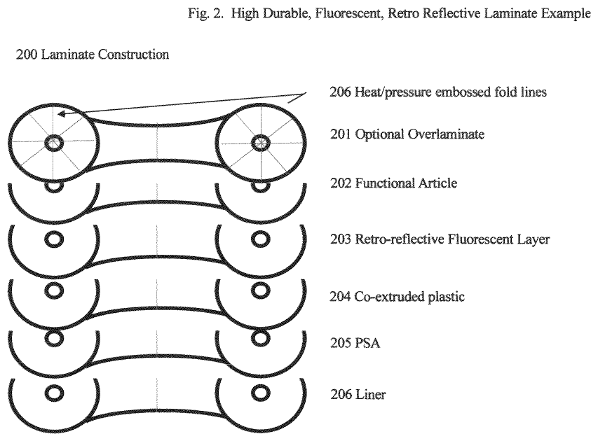

As shown in FIG. 2, this invention provides a manufacturing method, a design and application method for providing high brightness, durable, foldable, sealed, and fluorescent reflector that can be placed in multiple locations on the bike in a combination not previously found in the art. The 200-laminate construction may include the following layers, the 201 optional overlaminate, the 202 functional articles, consisting of the 203 Retro-reflective Fluorescent Layer, the 204 Co-Extruded Plastic and the 205 PSA Layer, and finally, the 206 Liner. There should also be at least one 206 Heat Embossed Fold Line to allow folding to the final design shape (Origami fold).

The reflectors are made from a flexible, air gap prism, fluorescent film that can be die cut, molded, welded, sealed, printed, and shaped into various configurations.

The shapes can be die-cut, electronically cut, laser cut, digitally printed, ultrasonically welded and edge sealed to provide environmental durability. Specifically, a combination of heat and pressure applied through one or more of the manufacturing methods provides a unique and useful result that enables tight radius folding and wrapping. The process may require temperatures that approach the material melt point with sufficient pressure to die-cut the shapes from the web, and to crush and/or melt the prisms together at the fold lines that create the origami type fold.

The shapes are prepared for folding by creating fold lines/areas in and on the film with sufficient heat and pressure applied to compress the micro-replicated prism structure into the backing/sealing film.

This manufacturing process allows the film to be folded with radii less than ¼″, which allows the film to be wrapped around bicycle spokes, rim edges and cables, which typically have smaller radii.

In addition, the invention may be attached to moving parts of the bike, increasing the bicycle's visual presence. Optimum placement may include the bicycles spokes, rims, pedals, handlebars, seat posts, frames, and crank. In addition, the reflector may be placed on other portions of the bicycle or rider to provide additional reflectance and an outline. Citation: Fekety, Drea Kevin, “Using Motion Perception to Improve the Nighttime Conspicuity of Bicyclists at Street Crossings” (2018). All Dissertations. 2222.

https://tigerprints.clemson.edu/all_dissertations/2222

### Specific Examples

### Dog Bone

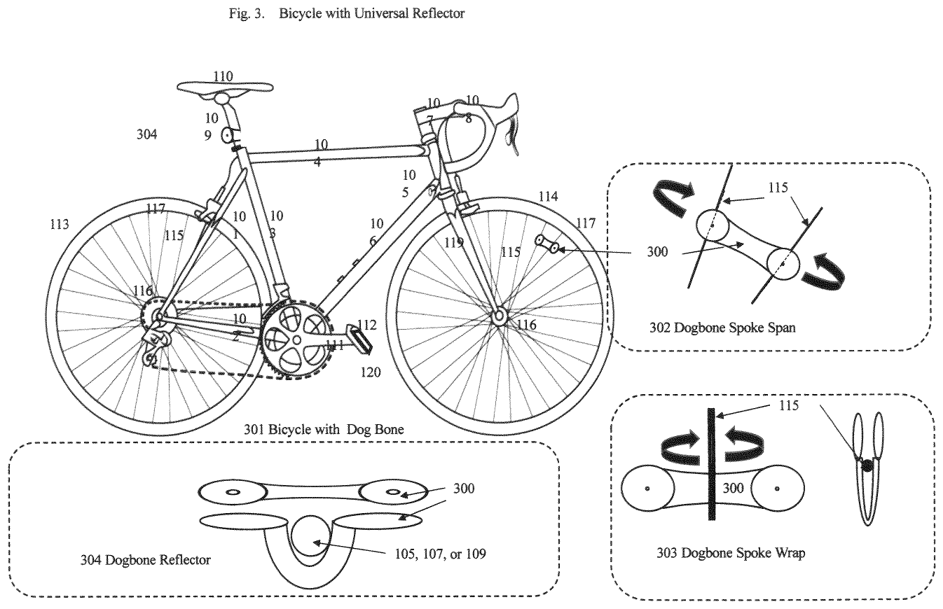

In FIG. 3, Bicycle with Universal Reflector, the 300 Dog Bone is a “universal” reflector that may be applied between different spoke patterns and spacing, avoiding the need for special, or unique design for each different spoke pattern, thus creating the 301 Bicycle with Dog Bone with either the 302 Dog Bone Span or 303 Dog Bone Spoke Wrap. The 302 Dog Bone Span is installed by aligning the 305 Center Hole over at least two spokes and folding the circle tab around the spoke and onto the back surface of the 300 Dog Bone. Alternatively, the 300 Dog Bone may be folded around a single spoke with the two 305 center holes aligned.

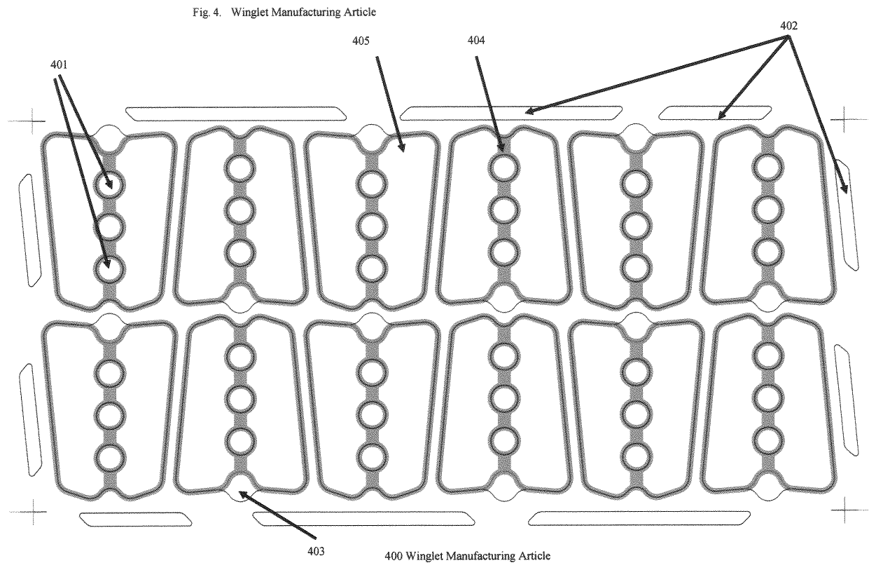

In addition, as shown in FIG. 4, the Dog Bone may be placed around the 105 front steerer tube and folded to make a front reflector, or placed around the 109 rear seat post, and folded to make a back reflector as show in the 304 Dog Bone Reflectors.

### Pedal and Pedal Crank Reflectors

This 200 Reflector design may be laminated over existing pedal reflectors, improving reflectance performance and 24-hour visibility while using the existing reflector mounting systems.

The preferred embodiments are the Winglet, Ringlet and Rim Wrap.

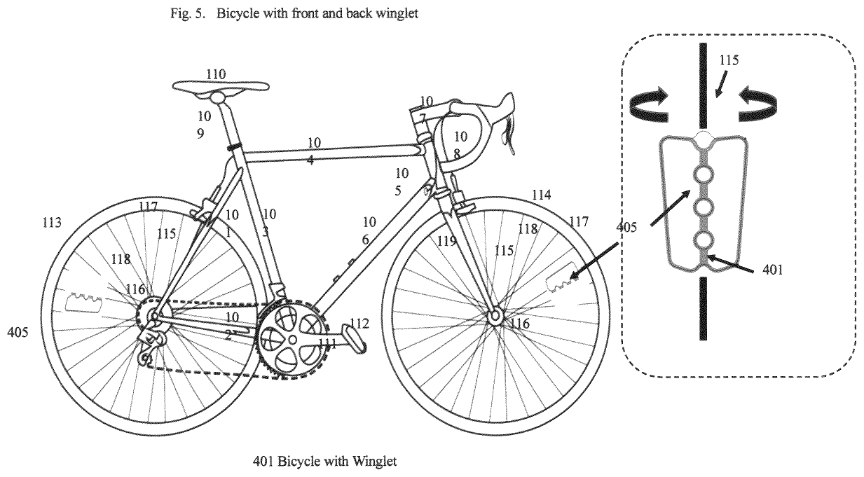

Winglet: The Winglet is an Origami fluorescent reflector shape, shown in FIG. 4, the 400 Winglet Manufacturing Article. This shape is designed to attach to the bicycle spokes, wrapping round the spoke, as shown in FIG. 5, with the Wing following behind the leading edge of the spoke. This provides an aerodynamic, lightweight, fluorescent reflector that is visible from both sides of the bicycle. Placing the reflector on 3-4 of the spokes, separated by the unflagged spokes, provides both an aesthetic arrangement and provides a strobing effect as the wheel rotates, which is shown to be most recognizable by the human visual system. The 403 Application tab is useful to the application.

One example, with a 12-unit pattern die is shown in FIG. 4. The die cutting heat and temperatures are in the range of 20-80 tons and platen temperatures up to 550 F, depending on the processing equipment and die set up. To maximize material usage, the 403-assembly tab, and 401 Hot Dots, and the 402 Flaers may be placed on other parts of the bicycle and/or rider to provide additional conspicuity opportunities for the cyclist.

Item 401, Hot Dots are the three punchouts that allow the Winglet to be applied to a bicycle spoke and are repurposed as dots for use on helmets or frames.

Item 402, Flaers are 4″×½″ and 2″×½″ products, taken from the waste areas of the 12-up die, to minimize waste and are designed for use on bicycle frames, helmets, shoes, backpacks, or pedals to increase conspicuity.

This 403 Tab facilitates the removal of the film liner and is removed at the same time as the liner. While not designed for a specific use, it can be used on a helmet or frame to increase conspicuity of the cyclist.

### Ringlet

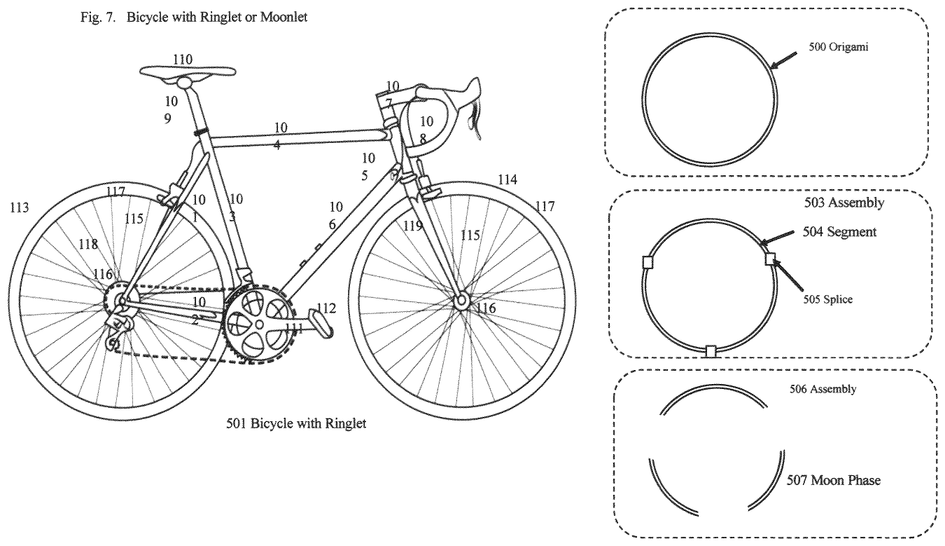

This allows the reflector to be used on bicycles with disc brakes or bikes with deep dish wheels as shown in FIG. 7, the 501 Ringlet Bicycle. Prior to this invention, application of a fluorescent and/or retroreflective circular ring was only possible on the tire (non-fluorescent) or on the wheel rim from a roll (non-fluorescent) or with difficult to align separate pieces to the rim (fluorescent and retroreflective). Also, prior to this invention whole sheets of material would have to be used to make this ˜25″+ring (for adult sized bikes) with high waste.

Additional form factors of this product can be made using fewer arcs, the 506 Assembly show in FIG. 7., (named Moonlet) to cover less of the wheel to create a “flashing” effect that leverages an increase in conspicuity as demonstrated by Drea et al.

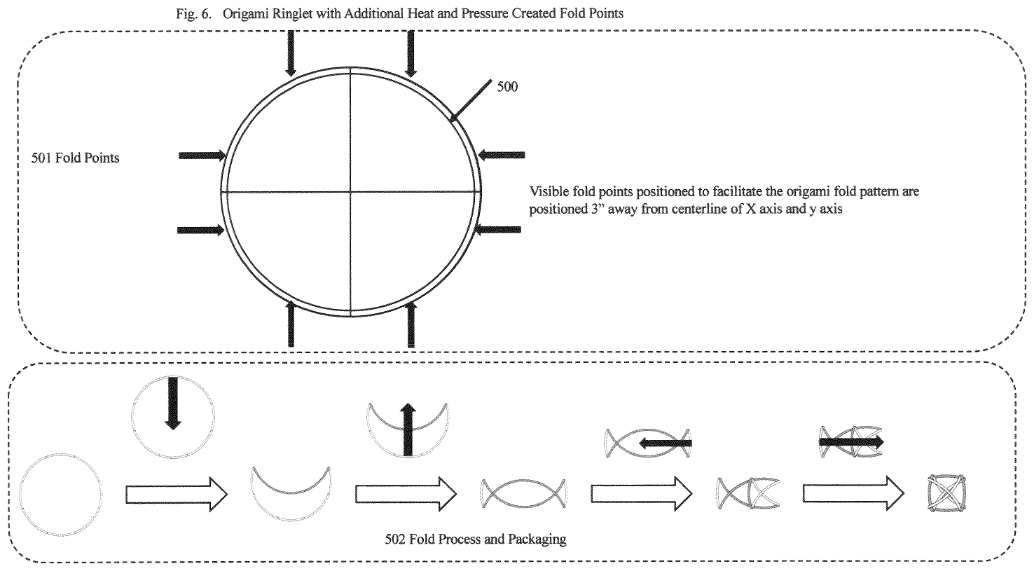

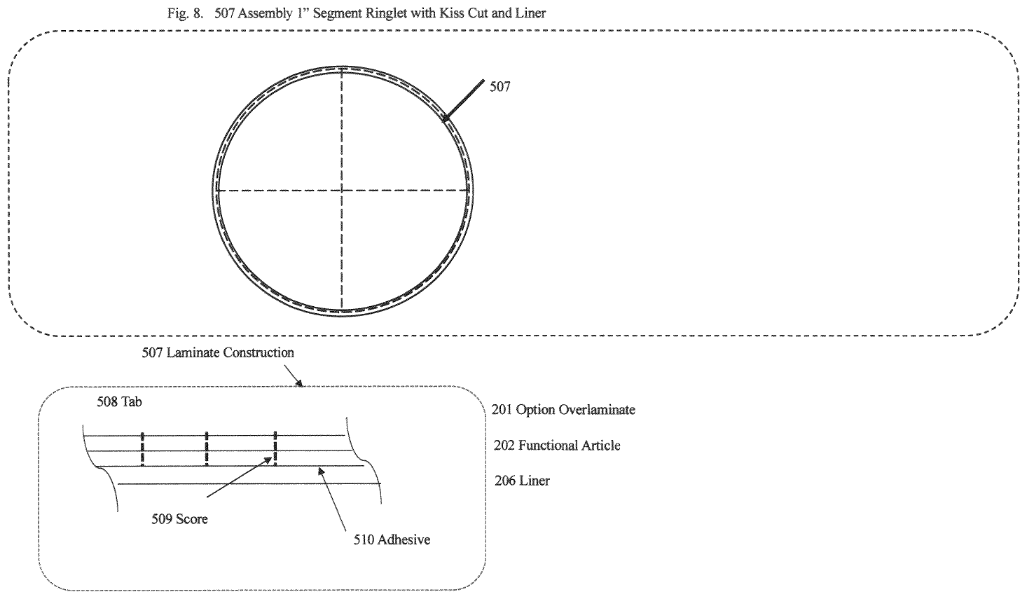

In the present invention, there are at least three embodiments, the folded 500 Origami, shown in FIG. 6 the 503-assembly shown in FIG. 7, or the 507 1″ Segment, shown in FIG. 8. First there may be segmented circular arcs, the 503 Assembly, show in FIG. 7 with pull tabs to aid in assembly, to be created. The pull tabs may be used to cover the gaps between segments to provide full coverage of the fluorescent reflective material around the rim.

Alternatively, the material leverages computational origami methods to “fold” the circle thus enabling minimal waste and promotes the upcycling of narrow width materials (material from other manufacturing processes, including thinner strips, and rolls of material can be used). This configuration is shown in FIG. 5, as the 500 Origami, with the 501-fold points, and the 502-Fold Process and Packaging.

This invention uses an origami fold pattern which ensures a perfect circle and fit. When folded, it can be shipped flat and then unfolded and easily applied with perfect, preformed alignment, quickly and accurately and allows for repositioning.

Application method on the wheel—The wheel or rim would be wiped down with an IPA wipe and any dirt or grease removed. Next the device would be unfolded and aligned with the wheel, where there was one “open” cut on the ring that would allow for application without removing the wheel. Next, the device would be aligned to the exact location on the wheel where it is meant to be applied. Using the building tabs, the 206 liner would be removed while pressing the device into place and activating the adhesive. Once the entire liner was removed, pressure or a squeegee would be used to activate the adhesive of the device in place. Finally, the pre-mask would be removed. This process would be repeated for each side of the wheel or for each wheel side.

The 500 Origami Ringlet consists of
the 202 Functional Article with Self Adhesive Fluorescent Reflective Material-edge sealed or edge printed. Fluorescent Reflective Material forms the permanently installed and functional portion of the device,
the 206 Release Liner. The Release liner is attached on the self-adhesive side of Item 1 and has an area greater than Item 1 but equal or greater to 201 Optional Overlaminate or Application Premask, and protects the adhesive, enables folds/hinges and is sacrificed upon installation.
the 201 Application premask. A stiff, lay flat paper or plastic mask that protects Item 1, enhances its lay flat characteristics, enables folds/hinges, and is sacrificed once Item 202 is installed.

The purpose of Items 201 and 206 is to ensure alignment, position-ability and protection of item 202 pieces and adhesive. Items 202 and 206 are necessary. Item 201 could potentially be left out of the design if Item 202 could demonstrate lay flat properties on its own.

Item 202 is sandwiched between 202 and 206. This sandwich is cut to various sizes to accommodate different wheel diameters to form a series of arcs that fit precisely on the rim of a wheel. These arcs, when combined, form a continuous fluorescent reflective ring which is then applied to a wheel (bicycle, motorcycle, motor vehicle, scooter, hoverboard, etc.). These arcs are connected by using 201 during application. The 206 Release Liner and 201 Optional Overlaminate made be made in continuous or segmented staggered fashion to create an origami folded construction which unfolds into the exact shape and size of the wheel or rim to which it is to be attached.

Sheets or rolls of 202-Fluorescent Retroreflective material would be laminated on the top with a suitable Item 201-a paper or plastic pre-mask. Next, the sheets or rolls of the combined 201 and 202 would be die cut, laser cut, electronically cut, or hand cut to form the arc shapes that would form the perfect circular ring for application to the wheel or rim. These would be cut in accordance with one of several origami fold patterns to facilitate smaller, flat shipment and easy alignment and application.

Once cut into the correct arc shapes, the arcs are aligned with a template tool to their intended circular ring shape, the original release liner is removed and a new, continuous, oversized 206 (widthwise) release liner is added to protect 202 adhesive. Finally, the wheel ring is origami folded on its cuts to form a smaller, easier to ship form factor that can be unfolded upon receipt by the customer and applied.

Additional elements that could be added to improve the invention include:
1) Tabs to pull off the release liner more easily.
2) Tabs that would facilitate the assembly of the circle-quick assembly of the circle.
3

) Staggering the fold/hinge mechanism so that the release liner is used as the non-cut fold/hinge for rear folds, and the pre-mask is used as the non-cut fold/hinge for front folds; and,
4) A staggered design approach to reuse the existing release liner instead of adding additional material.

### Rim Winglet

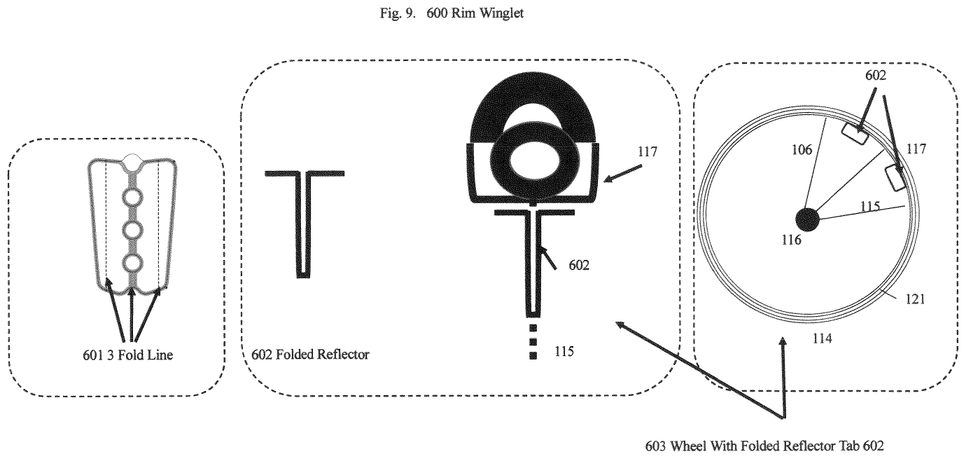

This allows the reflector to be used on both sides of a bicycle rim with either caliper or disc brakes as shown in FIG. 9, 600 Rim Winglet. Prior to this invention, application of a fluorescent retroreflective material was only possible on the rim if the material was in small non-conformable pieces. This invention uses the unique heat pressure manufacturing method to create the 601-fold lines to allow conformability without cracking or lifting due to material memory. Prior to this invention dirt incursion in open cells would reduce retroreflective and/or fluorescent performance.

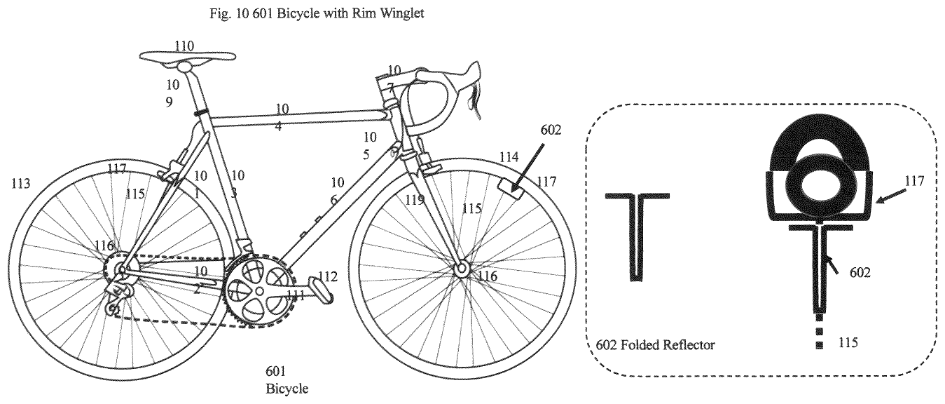

In another embodiment, the 600 Rim Winglet shape may be modified as shown in FIG. 10, the 601 Bicycle with at least one Rim Winglet, to attach to the bicycle rim inside circumference, allowing use on those bicycles using caliper brakes.

### Rim Wrap

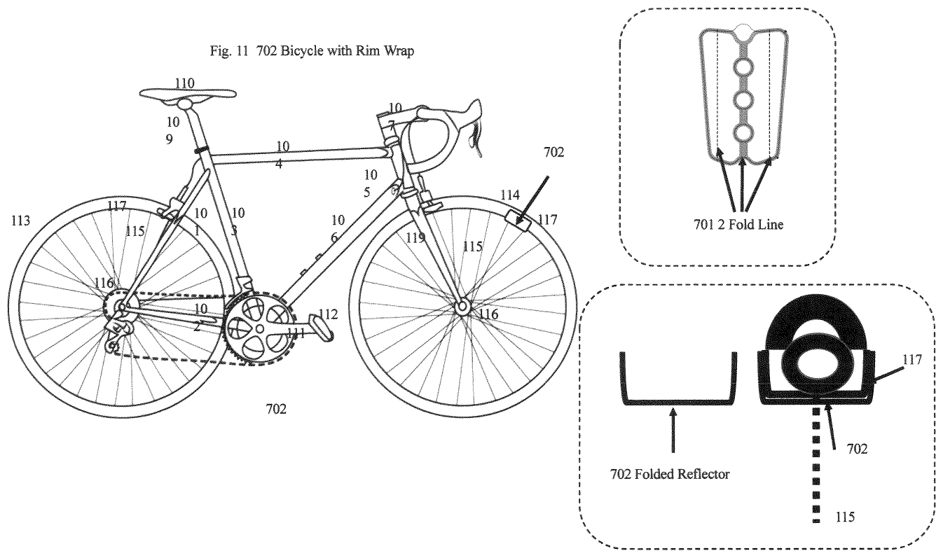

As an alternative to the full coverage Ringlet or the ½ coverage Moonlet piece, offering 4-6 small origami-designed wings to be attached to the outer rim of the bicycle to again take advantage of the increased conspicuity related to “flashing” or movement that can be see when reflectors are discontinuous. This is shown in FIG. 11, 702 Bicycle with Rim Wrap, where the folded shape has 2 701-fold lines that allow the reflector to conform against and adhere to, the 117-bicycle rim.

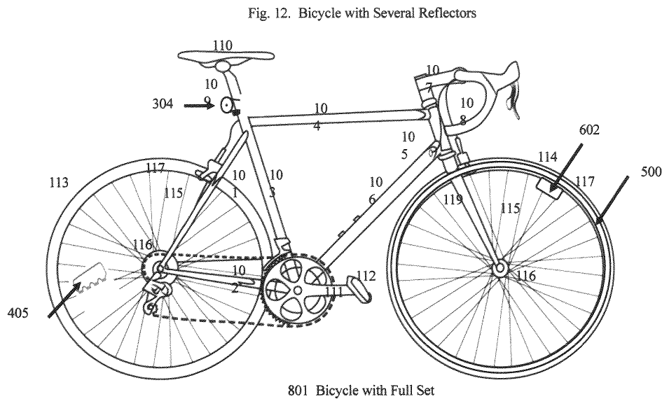

Finally, as shown in FIG. 12, various components can be applied together to meet and exceed current regulations.

The 405 Winglet, the segmented Ringlet and Wraps provide a flashing or strobing effect that triggers the human eye and brain bio motion sensing. The Full Ringlet provides large area reflectance, additionally creating a large visual profile.

Other invention Uses: Origami folds of fluorescent and/or retroreflective devices can be used to produce easily folded signs, placard fold up signs, endoskeletons like tent supports, game boards and other devices where a nominally 2-dimensional object would benefit from an alternative, smaller, flatter form factor.

1. A method of manufacturing that creates a micro-prismatic, retroreflective and fluorescent material with sealed edges and fold lines created by heating and embossing comprising these steps: 1) a cutting step that may include laser, die cut, eletro-cutting, 2) a heat and crushing step that may include using a heated die to seal the edges of a shape, or creates a fold line in the shape or creates a logo in the shape, 3) a printing step that creates a printed edge, a printed fold or a logo.

2. An article with high brightness, durable, foldable, sealed, and fluorescent retroreflector comprising: 1) a fold line that allows a radius of ¼″ or less, 2) a fluorescent material that converts ambient daylight or blue light into visible light, and 3) a retro reflection material that directs light from a source back to an observer, camera or detector and 4) and a performance that is at least 2 times more brightness than other standard reflectors.

3. The article of claim 2, where in the article is the DogBone, a universal reflector shape that is easily installed in several locations, including locations on a bicycle, which may include the spokes, the seat tube, the head tube, the handlebar or other locations.

4. The article of claim 2, wherein the article is Winglet which is easily installed by wrapping a single Winglet around a single bicycle spoke and provides a flashing bio-motion visual effect.

5. The article of claim 2, wherein the article is a Ringlet that is easily assembled using the Origami concept, assembly tools and methods and assembled onto the bicycle rim in a continuous ring with an adhesive with intermediate strength between the function material and adhesion to the bicycle rim and provides a complete definition of the bicycle front or back wheel to increase visibility.
The device of claim 2, wherein the article is a Segmented Ringlet, to allow individual pieces to be applied, or removed and can be used to provide a complete coverage of the bicycle rim or a partial coverage increasing bio-motion effect.

6. The article of claim 2, wherein the article is a Moonlet shape assembled to a bicycle rim to provide flashing bio-motion.

7. The article of claim 2, wherein the article is a Rim Winglet. The Rim Winglet is assembled to provide flashing bio-motion and may be used on devices with rim brakes.

8. A device comprising: 1) a bicycle and 2) at least one article of claim 2, claim 3, claim 4, claim 5, claim 6, or claim 7.
